(19) United States
(12) Patent Application Publication
(10) Pub. No.: US 2024/0318882 A1
(43) Pub. Date: Sep. 26, 2024

(54) AIRCRAFT FLUID MIXING SYSTEM AND ASSOCIATED AIRCRAFT

(71) Applicant: DASSAULT AVIATION, PARIS (FR)

(72) Inventor: Stéphane FERRET, SAINT CLOUD (FR)

(21) Appl. No.: 18/613,088

(22) Filed: Mar. 21, 2024

(30) Foreign Application Priority Data
Mar. 24, 2023 (FR) FR 23 02822

(51) Int. Cl. F25B 41/42; B64D 13/06

(52) U.S. Cl. CPC F25B 41/42; B64D 13/06

(57) ABSTRACT

An aircraft fluid mixing system is configured to mix first and second fluids to form a resulting fluid. The system and associated aircraft includes a main duct, an auxiliary duct and a connection device. The main duct includes a main tubular wall and a neutral fiber, the main tubular wall includes an upstream section for circulating the first fluid and a downstream section for circulating the resulting fluid. The auxiliary duct includes an auxiliary tubular wall for circulating the second fluid. The connection device is fluidically connecting the main duct and the auxiliary duct. The connection device includes an internal peripheral wall defining a plurality of injection openings for the second fluid into the main pipe. Each injection opening is arranged so that the second fluid is injected according to an injection vector. The direction of the second fluid is directed toward the neutral fiber.

The present disclosure relates to an aircraft fluid mixing system.

In particular, such a fluid mixing system is an airflow mixing system the purpose of which is to generate and distribute conditioned air at an optimum temperature in different parts of the aircraft fuselage. In particular, conditioned air is generated by mixing relatively cooler air (hereafter referred to as “cold air”) at a relatively low temperature with relatively warmer air (hereinafter referred to as “hot air”) at a relatively higher temperature.

### BACKGROUND

In known systems, cold air and hot air are mixed in a mixer in the shape of an elongated tube. In particular, cold and hot air are injected simultaneously into the tube in a direction substantially parallel to the longitudinal axis of the tube.

However, these fluid mixing systems are not entirely satisfactory. Cold and hot air are injected into the mixer at high speed, generating high levels of noise.

Typically, an acoustic device is installed on the mixer to attenuate this noise. However, the presence of this acoustic device significantly increases the footprint and mass of the system.

To obtain conditioned air at a predefined optimum temperature, which may be much lower than the temperature of the hot air, it is necessary to implement a mixer of considerable length. This further increases the footprint and mass of the system.

Lastly, state-of-the-art fluid mixing systems can present pressure losses, particularly in the upstream pipes carrying the cold air. Pumps may need to be installed to compensate for these pressure losses, which also contributes to the increase in mass and overall dimensions.

The fluid mixing systems of the state of the art can therefore be further optimized.

### SUMMARY

One aim of the present disclosure is to provide a fluid mixing system that is efficient and quiet, while at the same time presenting reduced mass and space requirements.

To this end, the present disclosure has as one of its object, an aircraft fluid mixing system configured to mix a first fluid and a second fluid to form a resulting fluid, the system comprising:
a main duct comprising a main tubular wall and presenting a neutral fiber, the main tubular wall comprising an upstream section defining an internal passage for circulation of the first fluid and a downstream section defining an internal passage for circulation of the resulting fluid;
an auxiliary duct comprising an auxiliary tubular wall defining an internal passage for circulation of the second fluid;
a connection device fluidically connecting the main duct and the auxiliary duct;
   the connection device comprising an internal peripheral wall defining a plurality of injection openings for injecting the second fluid into the main duct between the upstream section and the downstream section,
   each injection opening being arranged so that the second fluid is injected through said injection opening according to an injection vector the direction of which is directed toward the neutral fiber.

According to particular embodiments of the present disclosure, the fluid mixing system also presents one or more of the following features, taken alone or in any technically possible combination(s):
each injection vector extends in a plane substantially perpendicular to the neutral fiber;
the connection device comprises a portion for connection to the main duct and an portion for connection to the auxiliary duct, the portion for connection to the main duct being interposed between the upstream section and the downstream section of the main tubular wall;
the internal peripheral wall of the connection device comprises:
   an upstream annular connection region for connection to the upstream section of the main tubular wall; and
   a downstream annular connection region for connection to the downstream section of the main tubular wall;
   an intermediate annular region interposed between the upstream annular connection region of the internal peripheral wall and the downstream annular connection region of the internal peripheral wall;
      the upstream section of the main tubular wall comprising a downstream annular connection region for connection to the upstream annular connection region of the internal peripheral wall, the downstream section of the main tubular wall comprising an upstream annular connection region for connection to the downstream annular connection region of the internal peripheral wall;
the normal cross-sectional areas of the hollow tubular volume delimited respectively by:
the upstream annular connection region of the internal peripheral wall;
the downstream annular connection region of the internal peripheral wall;
the intermediate annular region of the internal peripheral wall;
the downstream annular connection region of the upstream section of the main tubular wall; and
the upstream annular connection region of the downstream section of the main tubular wall;
are substantially equal or present continuously differentiable evolutions along the neutral fiber;
the connection device comprises an upstream transverse wall and a downstream transverse wall substantially orthogonal to the neutral fiber of the main duct,
the connection device further comprising an external peripheral wall connecting the upstream and downstream transverse walls,
the upstream transverse wall, the downstream transverse wall, the external peripheral wall and the internal peripheral wall together delimiting an intermediate space for circulation of the second fluid from the auxiliary duct to the main duct;
the connection device defines a second-fluid inlet orifice in fluid communication with the auxiliary duct; and
the internal peripheral wall comprises an internal face and an external face, each injection opening extending from an external orifice delimited by the external face to an internal orifice delimited by the internal face;
the sum of the cross-sectional areas of the internal orifices on the internal face of the internal peripheral wall is greater than 1.5 times the cross-sectional area of the second-fluid inlet orifice;
the internal peripheral wall defines at least one first group of injection openings and at least one second group of injection openings,
the at least one first group of injection openings being arranged closer to the second-fluid inlet orifice relative to the at least one second group of injection openings,
the cross-sectional areas of the internal orifices of the injection openings of the at least one first group of injection openings being smaller than the cross-sectional areas of the internal orifices of the injection openings of the at least one second group of injection openings;
the injection openings are circular holes delimited by the inner peripheral wall;
the circular holes present a diameter of between 1 mm and 10 mm, preferably between 3 mm and 5 mm; and
the internal peripheral wall comprises fins delimiting the injection openings.

The present disclosure further relates to an aircraft comprising:
a first source of a first fluid;
a second source of a second fluid;
at least one volume for receiving the resulting fluid; and
a mixing system as described above;
the upstream section of the main duct being fluidically connected to the first source, the auxiliary duct being fluidically connected to the second source, the downstream section of the main duct being fluidically connected to the at least one resulting fluid receiving volume, the system being configured to distribute the resulting fluid into the at least one resulting fluid receiving volume.

According to particular embodiments of the present disclosure, the aircraft also presents one or more of the following features, taken alone or in any technically possible combination(s):
the aircraft is such that:
the first fluid presents a first temperature;
the second fluid presents a second temperature different from the first temperature; and
the resulting fluid presents a third temperature the value of which lies between the first and second temperatures.
   the first fluid, the second fluid and the resulting fluid are air.

### BRIEF SUMMARY OF THE DRAWINGS

Further features and advantages of the present disclosure will become apparent from the following description, given by way of example only and with reference to the appended drawings, in which:

FIG. 1 is a simplified schematic representation of an aircraft according to the present disclosure;

FIG. 2 is a side perspective view of part of a fluid mixing system included in the aircraft of FIG. 1, according to a first embodiment;

FIG. 3 is a top view of the system of FIG. 2;

FIG. 4 is a top perspective view of the system of FIGS. 2 and 3 in which the downstream transverse wall and the external peripheral wall of the connection device have been omitted;

FIG. 5 is a cross-sectional view of the system of FIGS. 2 to 4 according to a sectional plane V-V substantially perpendicular to the neutral fiber of the main duct;

FIG. 6 is a simplified schematic representation of a cross-sectional view of the system of FIGS. 2 to 5 according to a sectional plane similar to the sectional plane V-V;

FIG. 7 is a simplified schematic representation of a cross-sectional view of a fluid mixing system according to a second embodiment according to a sectional plane similar to sectional plane V-V.

### DETAILED DESCRIPTION

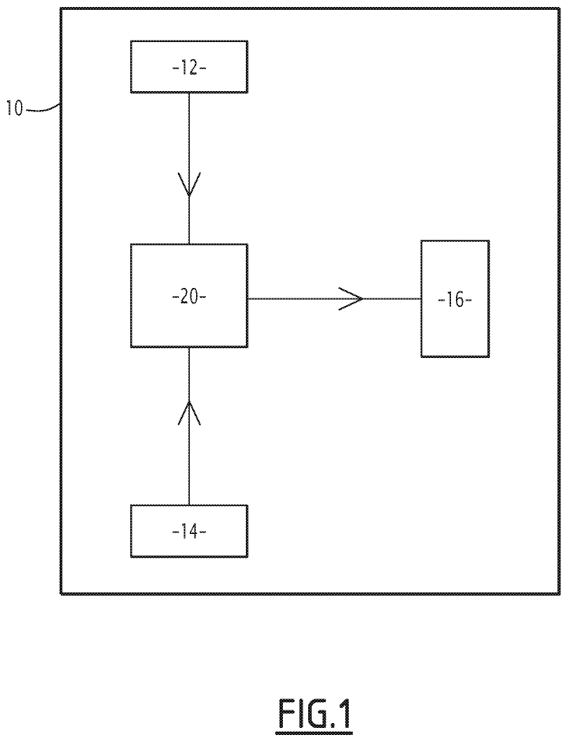

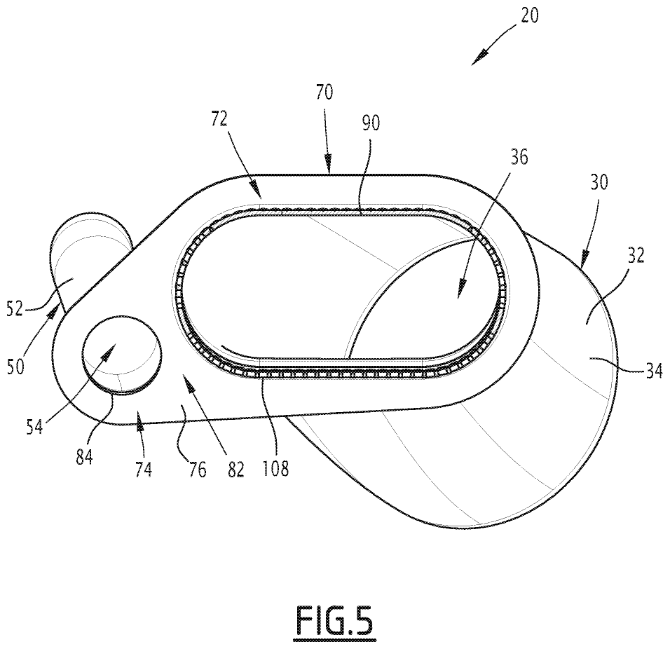

With reference to FIGS. 1 to 7, an aircraft 10 according to the present disclosure is described.

With reference to FIG. 1, the aircraft 10 comprises a first source 12 of a first fluid, a second source 14 of a second fluid, a fluid mixing system 20 for mixing the first fluid and the second fluid and at least one receiving volume 16 of a resulting fluid formed from the mixing of the first fluid and the second fluid in the mixing system 20.

According to the particular example shown in FIGS. 1 to 7, the fluid is air. In particular, the first fluid, the second fluid and the resulting fluid are air.

In particular, the first fluid presents a first temperature, the second fluid presents a second temperature different from the first temperature, and the resulting fluid presents a third temperature the value of which lies between the first and second temperatures. In particular, the resulting fluid is obtained by mixing the first fluid and the second fluid.

For example, the first temperature is between 1° C. and 30° C. For example, the second temperature is between 150° C. and 200° C. For example, the third temperature is between 5° C. and 80° C.

For example, the first source 12 of the first fluid is the aircraft power unit 10. The first source 12 is configured to supply the first fluid to the mixing system 20. For example, the first fluid is air from a first portion of at least one turbine of the aircraft 10, the air from this first portion being cooled before reaching the mixing system.

For example, the second source 14 of the second fluid is the power plant of the aircraft 10. The second source 14 is configured to supply the second fluid to the mixing system 20. In this example, the second fluid has a higher temperature than the first fluid. For example, the second fluid is air from a second portion of the at least one turbine of the aircraft 10, the second portion being distinct from the first portion.

For example, the at least one receiving volume 16 is the fuselage of the aircraft 10. The at least one receiving volume 16 is configured to receive the resulting fluid from the mixing system 20. In particular, the at least one receiving volume 16 is a cabin, cockpit or cargo hold of the aircraft 10.

The mixing system 20 is configured to distribute the resulting fluid into the at least one receiving volume 16.

The mixing system 20 comprises a main duct 30, an auxiliary duct 50 and a connection device 70 fluidically connecting the main duct 30 and the auxiliary duct 50.

Advantageously, the mixing system 20 further comprises equipment (non-illustrated), in particular valves, configured respectively to:
regulate the flow of the first fluid coming from the power unit of the aircraft 10;
regulate the flow rate of the second fluid coming from the aircraft power unit 10;
regulate the flow rate of the resulting fluid entering the at least one receiving volume 16.

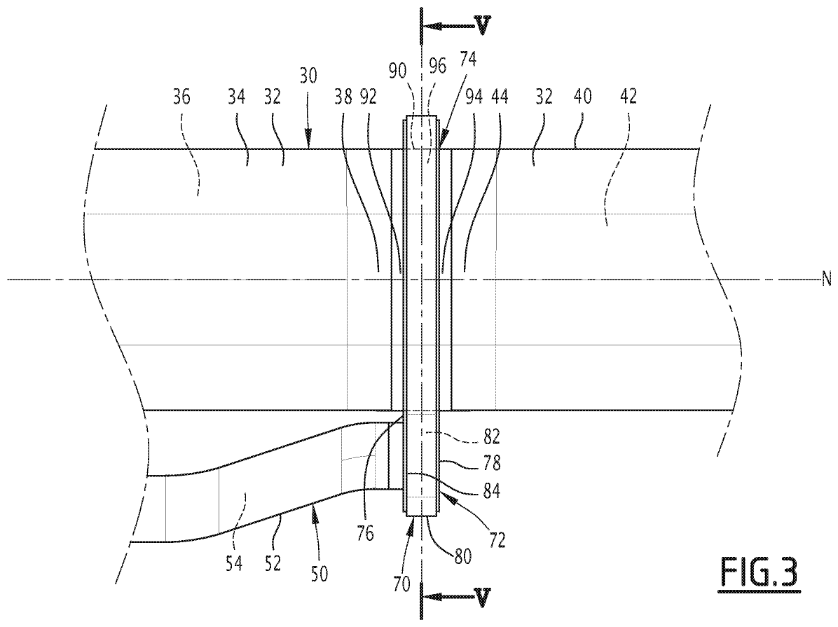

The main duct 30 comprises a main tubular wall 32 and presents a neutral fiber N (as illustrated in FIGS. 3, 6 and 7). By “neutral fiber” is meant a line passing through the center of gravity of the normal sections of the main tubular wall 32.

In particular, the main duct is fluidically connected to the first source 12 and to the at least one receiving volume 16.

The main tubular wall 32 comprises an upstream section 34 and a downstream section 40.

The upstream section 34 is fluidically connected to the first source 12 of the first fluid.

The upstream section 34 defines an internal passage 36 for circulation of the first fluid.

With reference to FIG. 3, the upstream section 34 notably comprises a downstream annular region 38 for connection to the connection device 70. In particular, the downstream annular connection region 38 is intended to connect to an upstream annular connection region 92 defined on an internal peripheral wall 90 of the connection device 70.

The downstream section 40 is fluidically connected to the at least one resulting fluid receiving volume 16.

The downstream section 40 defines an internal passage 42 for circulation of the resulting fluid.

In particular, the downstream section 40 comprises an upstream annular region 44 for connection to the connecting device 70. In particular, the upstream annular connection region 44 is intended to connect to a downstream annular connection region 94 defined on the internal peripheral wall 90 of the connection device 70.

The auxiliary duct 50 comprises an auxiliary tubular wall 52 defining an internal passage 54 for circulation of the second fluid.

The auxiliary duct 50 is fluidically connected to the second source 14.

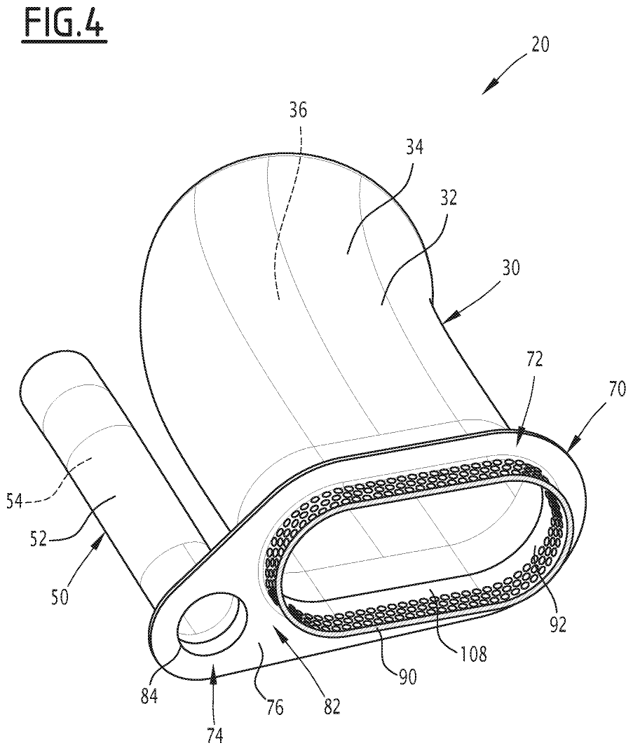

With reference to FIGS. 4 to 7, the auxiliary duct 50 opens out into a second-fluid inlet orifice 84 delimited by the connection device 70.

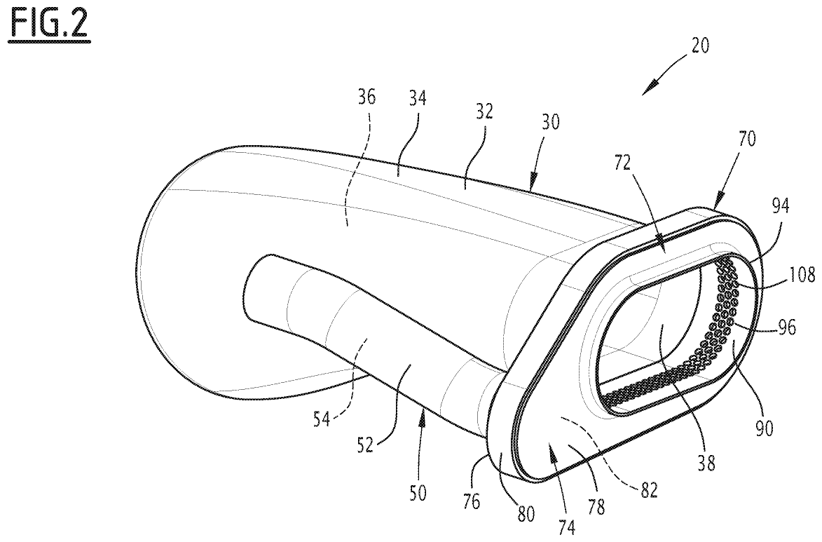

Advantageously, as illustrated in FIGS. 2 to 7, the connection device 70 comprises a portion 72 for connection to the main duct 30 and a portion 74 for connection to the auxiliary duct 50.

Advantageously, again with reference to FIGS. 2 to 7, the connection device 70 further comprises an upstream transverse wall 76, a downstream transverse wall 78 (visible only in FIGS. 2 and 3) and an external peripheral wall 80 (visible only in FIGS. 2 and 3) connecting the upstream transverse wall 76 and the downstream transverse wall 78.

With reference to FIGS. 2 to 7, the connection device 70 further comprises an internal peripheral wall 90 defining a plurality of injection openings 108 for injecting the second fluid into the main duct 30, each injection opening 108 being located between the upstream section 34 and the downstream section 40.

As illustrated in FIG. 3, the portion 72 connecting to the main duct 30 is interposed between the upstream section 34 and the downstream section 40 of the main tubular wall 32.

In particular, the portion 72 comprises the internal peripheral wall 90.

As illustrated in the examples of FIGS. 2 to 7, the portion 74, for connection to the auxiliary pipe 50, is arranged laterally relative to the connection portion 72, of the main duct 30, in a plane substantially perpendicular to the neutral fiber N.

In particular, the portion 74 comprises the inlet orifice 84 for supplying the second fluid.

The upstream transverse wall 76, the downstream transverse wall 78, the external peripheral wall 80 and the internal peripheral wall 90 together delimit an intermediate space 82 for circulation of the second fluid from the auxiliary duct 50 toward the main duct 30.

The intermediate space 82 fluidically connects the auxiliary duct 50 and the main duct 30. In particular, the space 82 fluidically connects the second-fluid inlet orifice 84 and each injection opening 108.

According to the examples illustrated in FIGS. 2 to 7, the upstream transverse wall 76 and the downstream transverse wall 78 are substantially orthogonal to the neutral fiber N of the main duct 30.

Advantageously, as illustrated in FIGS. 4 to 7, the upstream transverse wall 76 delimits the inlet orifice 84 for supplying the second fluid. In a non-illustrated alternative, the orifice 84 is delimited by the downstream transverse wall 78 or the external peripheral wall 80.

The inlet orifice 84 supplying the second fluid is in fluid communication with the auxiliary duct 50.

Advantageously, with reference to FIGS. 2 and 3, the internal peripheral wall 90 comprises the upstream annular region 92 for connection to the upstream section 34 of the main tubular wall 32, the downstream annular region 94 for connection to the downstream section 40 of the main tubular wall 32 and an intermediate annular region 96 interposed between the upstream annular region 92 and the downstream annular region 94.

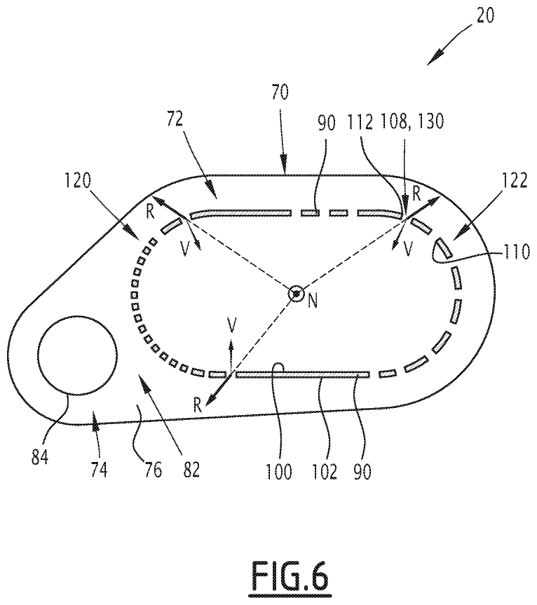

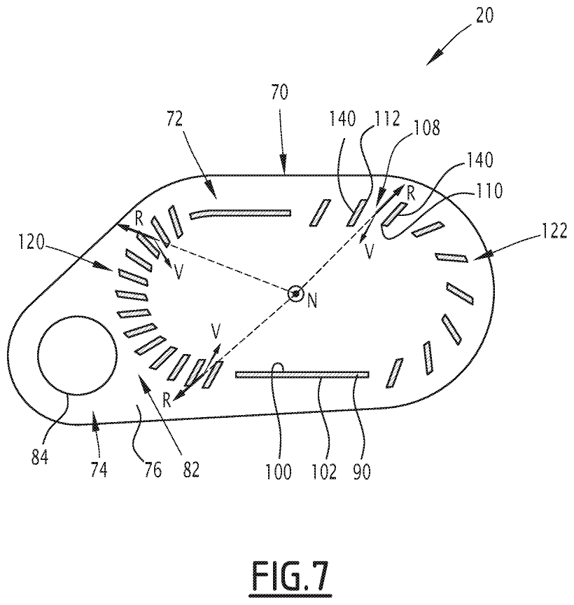

Even more advantageously, with reference to FIGS. 6 and 7, the internal peripheral wall 90 comprises an internal face 100 oriented toward the neutral fiber N and an external face 102 opposite the internal face 100.

The upstream annular region 92 for connection to the upstream section 34 of the main tubular wall 32 extends, particularly, as an extension of the downstream annular region 38 for connection to the upstream section 34.

The downstream annular region 94 for connection to the downstream section 40 of the main tubular wall 32 extends, particularly, as an extension of the upstream annular region 44 for connection to the downstream section 40.

Advantageously, the intermediate annular region 96 connects the upstream 92 and the downstream 94 annular regions. Even more advantageously, the intermediate annular region 96 extends as an extension of the upstream 92 and the downstream 94 annular regions.

In particular, the normal cross-sectional areas of the hollow tubular volume are delimited respectively by:
the upstream annular region 92 connecting the internal peripheral wall 90;
the downstream annular region 94 connecting the internal peripheral wall 90;
the intermediate annular region 96 of the internal peripheral wall 90;
the downstream annular connection region 38 of the upstream section 34 of the main tubular wall 32; and
the upstream annular region 44 connecting the downstream section 40 of the main tubular wall 32;
are substantially equal or present continuously derivable evolutions along the neutral fiber N. This produces a flow of the first fluid that is not disturbed by geometric variations in the normal cross-section of the hollow tubular volume in which it flows at the connection device.

With reference to FIGS. 2 and 4 to 7, the injection openings 108 are arranged so that the second fluid is injected through each of said injection openings 108 according to an injection vector V the direction of which is directed toward the neutral fiber N.

In particular, “directed toward the neutral fiber N” means that the scalar product between the radial vector R orthogonal to the neutral fiber N and the injection vector V is less than 0. C. This significantly limits the adhesion of the flow of the second fluid injected through an injection opening 108 to a wall facing said injection opening 108. Mixing of the second fluid with the first fluid is therefore improved. Indeed, here, the flow of the second fluid injected through said injection opening 108 is significantly away from any opposing wall.

In particular, as illustrated in the examples of FIGS. 6 and 7, each injection vector V extends in a plane substantially perpendicular to the neutral fiber N. Thus, the second fluid is injected orthogonally to the flow of the first fluid, which allows pressure losses in the system 20 and in the fluid circuit 10 of the aircraft in general to be reduced.

Advantageously, as illustrated in the example of FIGS. 2 and 3, the injection openings 108 are distributed around the entire periphery of the internal peripheral wall 90 of the connection device 70. This results in a better distribution of the second fluid flow through the injection openings 108 around the first fluid flow. As a result, mixing between the first and second fluids is more efficient.

In particular, as illustrated in the examples of FIGS. 6 and 7, each injection opening 108 extends from an external orifice 112 delimited by the external face 102 of the internal peripheral wall 90 to an internal orifice 110 delimited by the internal face 100 of the internal peripheral wall 90.

Advantageously, the sum of the cross-sectional areas of the internal orifices 110 of the inner peripheral wall 90 is greater by 1.5 times the cross-sectional area of the second-fluid inlet orifice 84. This produces an injection speed of the second fluid through the injection openings 108 that is sufficiently low to limit disturbances in the flow of the first fluid and therefore affect the resulting fluid flow less. For example, the injection speed of the second fluid through the injection openings 108 is less than 0.3 Mach.

According to the examples in FIGS. 6 and 7, the inner peripheral wall 90 defines at least one first group 120 of injection openings and at least one second group 122 of injection openings.

The at least one first group 120 of injection openings is arranged closer to the second-fluid inlet orifice 84 than the at least one second group 122 of injection openings. In particular, the distance between each injection opening of the first group 120 and the orifice 84, taken in the plane perpendicular to the neutral fiber N, is less than the distance between each injection opening of the second group 122 and the orifice 84, taken in the plane perpendicular to the neutral fiber N.

The cross-sectional areas of the internal orifices 110 of the injection openings 108 of the at least one first group 120 are smaller than the cross-sectional areas of the internal orifices 110 of the injection openings 108 of the at least one second group 122. This allows to obtain a second fluid injection flow as homogeneous as possible over the entire periphery of the internal peripheral wall. Indeed, the flow of the second fluid supplied in the space 82 is greater in the vicinity of the second-fluid inlet orifice 84 than it is away from said orifice 84. The speed of the second fluid in the space 82 is therefore greater in the vicinity of the orifice 84. A smaller size of the cross-sectional areas of the internal orifices 110 of the injection openings 108 of the first group 120 relative to those of the injection openings 108 of the second group 122 results in an injection flow of the second fluid that is substantially similar between the first and second groups 120, 122.

According to a first embodiment illustrated in FIGS. 2 to 6, the injection openings 108 are circular holes 130 delimited by the internal peripheral wall 90.

In particular, the circular holes 130 are drilled in the internal peripheral wall 90. According to one alternative, the internal peripheral wall 90 is manufactured by additive manufacturing and the circular holes 130 are delimited during additive manufacturing.

For example, the circular holes 130 present a diameter of between 1 mm and 10 mm, preferably between 3 mm and 5 mm.

According to a second embodiment illustrated in FIG. 7, the internal peripheral wall 90 comprises fins 140 delimiting the injection openings 108.

Advantageously, the fins 140 are manufactured by additive manufacturing. In particular, the fins 140 are produced during additive manufacturing of the internal peripheral wall 90, so that the fins 140 and the wall 90 form a single part.

In this second embodiment, for each injection opening 108, the internal orifice 110 is delimited by the internal ends of the corresponding fins 140 and the external orifice 112 is delimited by the external ends of the corresponding fins 140. The internal ends of the fins 140 are the ends closest to the neutral fiber N, and the external ends are the ends opposite the inner ends.

Thanks to the present disclosure, the mixing system 20 produces a resulting fluid efficiently. The noise generated by fluid flows and pressure losses are reduced. As a result, the system 20 according to the present disclosure avoids the need for hydraulic or acoustic devices to counteract noise or pressure drop. As a result, the weight and overall dimensions of system 20 are significantly reduced.

What is claimed is:

1. An aircraft fluid mixing system configured to mix a first fluid and a second fluid to form a resulting fluid, the system comprising:
a main duct comprising a main tubular wall and presenting a neutral fiber, the main tubular wall comprising an upstream section defining an internal passage for circulation of the first fluid and a downstream section defining an internal passage for circulation of the resulting fluid;
an auxiliary duct comprising an auxiliary tubular wall defining an internal passage for circulation of the second fluid; and
a connection device fluidically connecting the main duct and the auxiliary duct;
the connection device comprising an internal peripheral wall defining a plurality of injection openings for injecting the second fluid in the main duct between the upstream section and the downstream section,
each injection opening being arranged so that the second fluid is injected through said injection opening according to an injection vector a direction of the second fluid is directed toward the neutral fiber.

2. The system according to claim 1, wherein each injection vector extends in a plane substantially perpendicular to the neutral fiber.

3. The system according to claim 1, wherein the connection device is comprising a portion for connection to the main duct and a portion for connection to the auxiliary duct, the portion for connection to the main duct being interposed between the upstream section and the downstream section of the main tubular wall.

4. The system according to claim 1, wherein the internal peripheral wall of the connection device is comprising:
an upstream annular connection region for connection to the upstream section of the main tubular wall;
a downstream annular connection region for connection to the downstream section of the main tubular wall; and
an intermediate annular region interposed between the upstream annular connection region of the internal peripheral wall and the downstream annular connection region of the internal peripheral wall;
the upstream section of the main tubular wall comprising a downstream annular connection region for connection to the upstream annular connection region of the internal peripheral wall,
the downstream section of the main tubular wall comprising an upstream annular connection region for connection to the downstream annular connection region of the internal peripheral wall.

5. The system according to claim 4, wherein a normal cross-sectional areas of a hollow tubular volume delimited by respectively:
the upstream annular connection region of the internal peripheral wall;
the downstream annular connection region of the internal peripheral wall;
the intermediate annular region of the internal peripheral wall;
the downstream annular connection region of the upstream section of the main tubular wall; and
the upstream annular connection region of the downstream section of the main tubular wall;
are substantially equal or present continuously differentiable evolution along the neutral fiber.

6. The system according to claim 1, wherein the connection device is comprising:
an upstream transverse wall and a downstream transverse wall substantially orthogonal to the neutral fiber of the main duct,
the connection device further comprising an external peripheral wall connecting the upstream and downstream transverse walls,
the upstream transverse wall, the downstream transverse wall, the external peripheral wall and the internal peripheral wall together delimiting an intermediate space for circulation of the second fluid from the auxiliary duct toward the main duct.

7. The system according to claim 1, wherein:
the connection device defines a fluid inlet orifice for the second fluid, in fluidic communication with the auxiliary duct; and
the internal peripheral wall comprises an internal face and an external face, each injection opening extending from an external orifice delimited by the external face to an internal orifice delimited by the internal face.

8. The system according to claim 7, wherein a sum of cross-sectional areas of the internal orifices of the internal face of the internal peripheral wall is greater than 1.5 times the cross-sectional area of the fluid inlet orifice for the second fluid.

9. The system according to claim 7, wherein the internal peripheral wall defines at least one first group of injection openings and at least one second group of injection openings,
the at least one first group of injection openings being arranged closer to the fluid inlet orifice for the second fluid relative to the at least one second group of injection openings,
cross-sectional areas of the internal orifices of the injection openings of the at least one first group of injection openings being smaller than the cross-sectional areas of the internal orifices of the injection openings of the at least one second group of injection openings.

10. The system according to claim 1, wherein the injection openings are circular holes delimited by the internal peripheral wall.

11. The system according to claim 10, wherein the circular holes present a diameter of between 1 mm and 10 mm, preferably between 3 mm and 5 mm.

12. The system according to claim 11, wherein the circular holes present a diameter of between 3 mm and 5 mm.

13. The system according to claim 1, wherein the internal peripheral wall comprises fins delimiting the injection openings.

14. An aircraft comprising:
a first source of a first fluid;
a second source of a second fluid;
at least one volume for receiving the resulting fluid; and
a system according to claim 1;
the upstream section of the main duct being fluidically connected to the first source, the auxiliary duct being fluidically connected to the second source, the downstream section of the main duct being fluidically connected to the at least one resulting fluid receiving volume,
the system being configured to distribute the resulting fluid into the at least one resulting fluid receiving volume.

15. The aircraft according to claim 14, wherein:
the first fluid presents a first temperature;
the second fluid presents a second temperature different from the first temperature; and
the resulting fluid presents a third temperature a value of which lies between the first and second temperatures.

16. The aircraft according to claim 14, wherein the first fluid, the second fluid and the resulting fluid are air.
